(19) United States
(12) Patent Application Publication
(10) Pub. No.: US 2024/0031263 A1
(43) Pub. Date: Jan. 25, 2024

(54) METHODS AND APPARATUS TO IMPROVE MANAGEMENT OPERATIONS OF A CLOUD COMPUTING ENVIRONMENT

(71) Applicant: VMWARE, INC., Palo Alto, CA (US)

(72) Inventors: VINEETH TOTAPPANAVAR, Bangalore (IN); ASWATHY RAMABHADRAN, Bangalore (IN); VINOTHKUMAR D, Bangalore (IN); RAHUL SINGH, Bangalore (IN); VENKATA PADMA KAKI, Bangalore (IN)

(21) Appl. No.: 17/976,961

(22) Filed: Oct. 31, 2022

(30) Foreign Application Priority Data
Jul. 22, 2022 (IN) 202241042074

(51) Int. Cl. H04L 43/0811; H04L 41/0816; H04L 9/14

(52) U.S. Cl. CPC H04L 43/0811; H04L 41/0816; H04L 9/14

(57) ABSTRACT

Methods, apparatus, systems, and articles of manufacture are disclosed to improve management operations of a cloud computing environment. An example apparatus includes at least one memory, machine readable instructions, and processor circuitry to at least one of instantiate or execute the machine readable instructions to determine a connectivity status between a first agent operating on a proxy server and a second agent operating on a compute node, the first agent and the second agent executing an application monitoring service, in response to determining that the connectivity status is indicative of a failed connection between the first agent and second agent, update the connectivity status of the second agent, and obtain an instruction to rectify the failed connection, and resolve that failed connection between the first agent and the second agent.

### RELATED APPLICATIONS

Benefit is claimed under 35 U.S.C. 119(a)-(d) to Foreign Application Serial No. 202241042074 filed in India entitled “METHODS AND APPARATUS TO IMPROVE MANAGEMENT OPERATIONS OF A CLOUD COMPUTING ENVIRONMENT”, on Jul. 22, 2022, by VMware, Inc., which is herein incorporated in its entirety by reference for all purposes.

### FIELD OF THE DISCLOSURE

This disclosure relates generally to cloud computing environments and, more particularly, to methods and apparatus to improve management of a cloud computing environment.

### BACKGROUND

Computing environments often include many virtual and physical computing resources. For example, software-defined data centers (SDDCs) are data center facilities in which many or all elements of a computing infrastructure (e.g., networking, storage, CPU, etc.) are virtualized and delivered as a service. The computing environments often include management resources for facilitating management of the computing environments and the computing resources included in the computing environments. Some of these management resources include the capability to automatically monitor computing resources and generate alerts when compute issues are identified. Additionally or alternatively, the management resources may be configured to provide recommendations for responding to generated alerts. In such examples, the management resources may identify computing resources experiencing issues and/or malfunctions and may identify methods or approaches for remediating the issues. Recommendations may provide an end user(s) (e.g., an administrator of the computing environment) with a list of instructions or a series of steps that the end user(s) can manually perform on a computing resource(s) to resolve the issue(s). Although the management resources may provide recommendations, the end user(s) is responsible for implementing suggested changes and/or performing suggested methods to resolve the compute issues.

### BRIEF DESCRIPTION OF THE DRAWINGS

FIG. 1 is a block diagram of an example computing environment in which example cloud management circuitry of an example cloud proxy is configured to manage connectivity of application monitoring agents corresponding to example resource platform(s).

FIG. 2 is an example data flow diagram illustrating an example installation process of a primary agent and a secondary agent.

FIG. 3 is a block diagram of the example cloud management circuitry of FIG. 1 to identify connectivity issues of application monitoring agents and rectify the connectivity issues.

FIG. 4A illustrates an example first user interface to display commands and responses of example secondary agent(s) of FIG. 1.

FIG. 4B illustrates an example second user interface to display application information corresponding to example secondary agents of FIG. 1.

FIG. 5 is a flowchart representative of example machine readable instructions and/or example operations that may be executed by example processor circuitry to implement the cloud management circuitry of FIGS. 1 and 3 to identify a connectivity issue and resolve the issue.

FIGS. 6 and 7 are flowcharts representative of example machine readable instructions and/or example operations that may be executed by example processor circuitry to implement the cloud management circuitry of FIGS. 1 and 3 to resolve the connectivity issue.

FIG. 8 is a block diagram of an example processing platform including processor circuitry structured to execute the example machine readable instructions and/or the example operations of FIGS. 5-7 to implement the cloud management circuitry of FIGS. 1 and 3.

FIG. 9 is a block diagram of an example implementation of the processor circuitry of FIG. 8.

FIG. 10 is a block diagram of another example implementation of the processor circuitry of FIG. 8.

FIG. 11 is a block diagram of an example software distribution platform (e.g., one or more servers) to distribute software (e.g., software corresponding to the example machine readable instructions of FIGS. 5-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

### DETAILED DESCRIPTION

The figures are not to scale. Instead, the thickness of the layers or regions may be enlarged in the drawings. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

Virtual computing services enable one or more assets to be hosted within a computing environment. As disclosed herein, an asset is a computing resource (physical or virtual) that may host a wide variety of different applications such as, for example, an email server, a database server, a file server, a web server, etc. Example assets include physical hosts (e.g., non-virtual computing resources such as servers, processors, computers, etc.), virtual machines, containers that run on top of a host operating system without the need for a hypervisor or separate operating system, hypervisor kernel network interface modules, etc. In some examples, an asset may be referred to as a compute node, an end-point, a data computer end-node or as an addressable node.

Virtual machines operate with their own guest operating system on a host using resources of the host virtualized by virtualization software (e.g., a hypervisor, virtual machine monitor, etc.). Numerous virtual machines can run on a single computer or processor system in a logically separated environment (e.g., separated from one another). A virtual machine can execute instances of applications and/or programs separate from application and/or program instances executed by other virtual machines on the same computer.

Management applications (e.g., cloud management such as vRealize® Automation Cloud Assembly) provide administrators visibility into the condition of assets in a computing environment (e.g., a data center). Administrators can inspect the assets, see the organizational relationships of a virtual application, filter log files, overlay events versus time, manage the lifecycle of the assets in the computing environment, troubleshoot during mission critical issues, etc. In some examples, an application may install one or more plugins (sometimes referred to herein as “agents”) at the asset to perform monitoring operations. For example, a first management application may install a first monitoring agent at an asset to track an inventory of physical resources and logical resources in a computing environment, a second management application may install a second monitoring agent at the asset to provide real-time log management of events, analytics, etc., and a third management application may install a third monitoring agent to provide operational views of trends, thresholds and/or analytics of the asset, etc.

In some systems (e.g., such as vRealize® Automation), a user and/or administrator may set up and/or create a cloud account (e.g., a Google® cloud platform (GCP) account, a network security virtualization platform (NSX) account, a VMware® cloud foundation (VCF) account, a vSphere® account, etc.) to connect a cloud provider and/or a private cloud so that the management applications can collect data from regions of datacenters. Additionally, cloud accounts allow a user and/or administrator to deploy and/or provision cloud templates to the regions. A cloud template is a file that defines a set of resources. The cloud template may utilize tools to create server builds that can become standards for cloud applications. A user and/or administrator can create cloud accounts for projects in which other users (e.g., team members) work. The management applications periodically perform checks on the cloud accounts to verify that the accounts are healthy (e.g., the credentials are valid, the connectivity is acceptable, the account is accessible, etc.).

For efficient operation between a management application and a monitoring agent at an asset, the system hosting the management application and the asset need to be connected and stay connected (until a user decides that the monitoring agent is no longer needed). In some examples, when an issue with the connectivity between system and the asset occurs, there is no way for a user (e.g., a system administrator, an end user, etc.) to know until attempting to access (e.g., obtain information from) the asset. In such an example, the management application will not collect data and, thus, will not enable troubleshooting during mission critical issues, correcting of any software issues that arise during execution, nor enable life cycle management capabilities to the applications running on the assets.

Examples disclosed herein provide users (e.g., system administrators, end users, etc.) with access to a connectivity status between a management application and one or more monitoring agents. For example, examples disclosed herein include circuitry that monitors the connectivity between the system hosting the management application and respective assets hosting the monitoring agents. Examples disclosed herein provide users with an ability to rectify the connection in an example where a connection has been terminated. For example, examples disclosed herein include rectification circuitry that identifies how the connection was terminated and uses that information to reestablish the connection between the management application and respective asset(s).

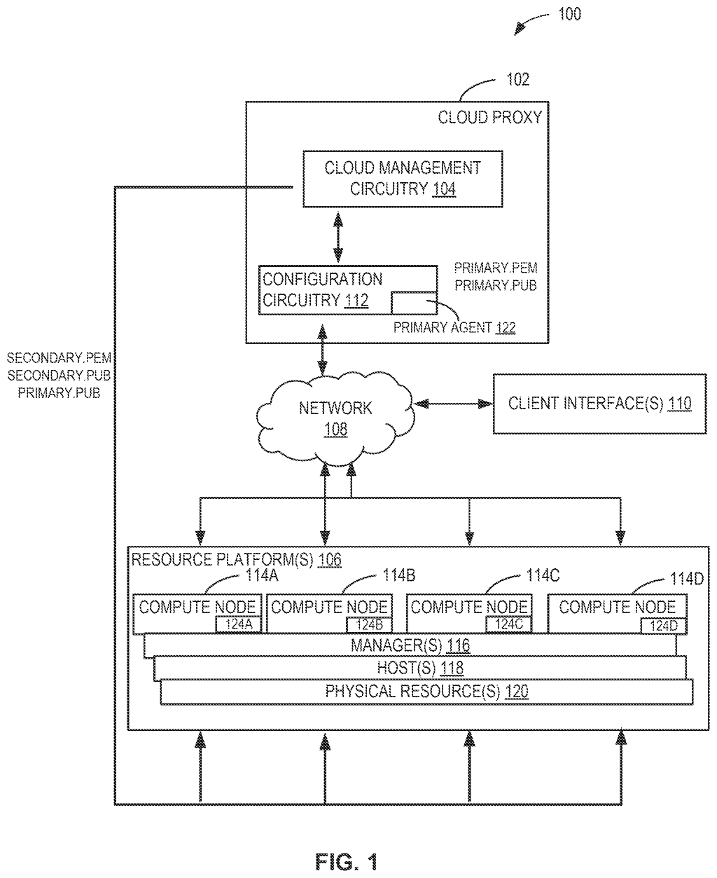

FIG. 1 is a block diagram of an example computing environment 100 in which example cloud management circuitry 104 of an example cloud proxy 102 is configured to manage connectivity of application monitoring agents corresponding to example resource platform(s) 106. The example computing environment 100 includes the example cloud proxy 102, the example cloud management circuitry 104, the example resource platform(s) 106, an example network 108, and example client interface(s) 110. The example cloud proxy 102 includes example configuration circuitry 112. The example resource platform(s) 106 include(s) example compute nodes 114a-c, example manager(s) 116, example host(s) 118, and example physical resource(s) 120. The example computing environment 100 may be a software-defined data center (SDDC). Alternatively, the example computing environment 100 may be any type of computing resource environment such as, for example, any computing system utilizing network, storage, and/or server virtualization.

The example cloud proxy 102 of FIG. 1 is proxy server (e.g., a type of server) that connects cloud services to on-premise data centers (e.g., resource platform(s) 106). The example cloud proxy 102 is a virtual appliance that is deployed in an example computing environment (e.g., the computing environment 100). The example cloud proxy 102 includes the cloud management circuitry 104 to call containers of specific agents for various services (e.g., application monitoring services) and supports data communication between the computing environment 100 and cloud computing environments (e.g., a cloud computing environment provided by the resource platform(s) 106). In some examples, the cloud proxy 102 enables lifecycle management of platform resource(s) 106. The example cloud proxy 102 includes the cloud management circuitry 104.

The example cloud management circuitry 104 of FIG. 1 manages cloud computing environments (e.g., a cloud computing environment provided by the example resource platform(s) 106). In some examples, the example cloud management circuitry 104 automatically allocates and provisions applications and/or computing resources to end users. To that end, the example cloud management circuitry 104 may include a computing resource catalog from which computing resources can be provisioned. The example cloud management circuitry 104 provides deployment environments in which an end user such as, for example, a software developer, can deploy or receive an application(s). In some examples, the example cloud management circuitry 104 may be implemented using a vRealize® Automation system developed and sold by VMware®, Inc. In other examples, any other suitable cloud computing platform may be used to implement the cloud management circuitry 104.

The example cloud management circuitry 104 of FIG. 1 may collect information about, and measure performance related to the example network 108, the example compute nodes 114a-d, the example manager(s) 116, the example host(s) 118, and/or the example physical resource(s) 120. For example, the cloud management circuitry 104 may implement and/or manage an application monitoring service, such as SaltStack owned and sold by VMware®, which enables users and/or administrators to automate lifecycle management for applications running on the compute nodes 114a-d. In some examples, the example cloud management circuitry 104 generates performance and/or health metrics corresponding to the example resource platform 106 and/or the example network 108 (e.g., bandwidth, throughput, latency, error rate, etc.). In some examples, the cloud management circuitry 104 accesses the resource platform(s) 106 to provision computing resources and communicates with a resource manager.

A user and/or administrator may set up and/or create a cloud account (e.g., a Google® cloud platform (GCP) account, a network security virtualization platform (NSX) account, a VMware® cloud foundation (VCF) account, a vSphere® account, etc.) to connect a cloud provider and/or a private cloud so that the cloud management circuitry 104 of FIG. 1 can collect data from regions of datacenters and/or to allow a user and/or administrator to deploy and/or provision cloud templates to the regions. A cloud template is a file that defines a set of resources. The cloud template may utilize tools to create server builds that can become standards for cloud applications. The example cloud management circuitry 104 of FIG. 1 may create and/or instantiate the example configuration circuitry 112 to communicate with regions of datacenters (e.g., from resource platform(s) 106) to execute commands issued by the cloud management circuitry 104.

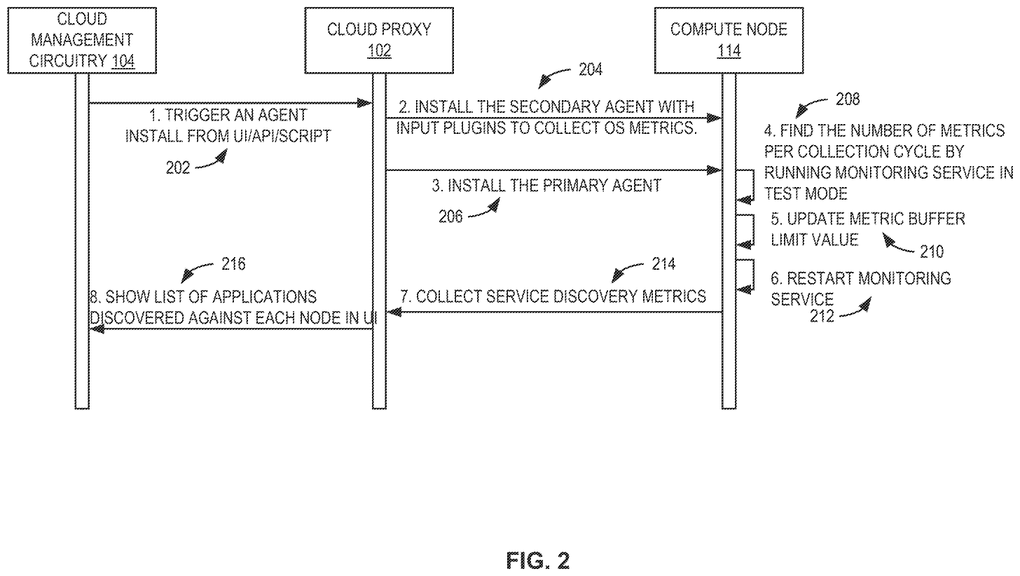

The example configuration circuitry 112 of FIG. 1 is a computing resource (e.g., a virtual and/or physical computing resource) that hosts an example primary agent 122, installed by the example cloud management circuitry 104. In some examples, the primary agent 122 is a plugin that acts as the main connection point between the cloud management circuitry 104 and the compute nodes 114a-d with respect to application monitoring services. For example, the configuration circuitry 112 distributes commands (e.g., jobs), issued by the cloud management circuitry 104, to respective compute nodes 114a-d. In some examples, the primary agent 122 requests metric data from the secondary agent(s) 124a-d. The example configuration circuitry 112 access jobs and/or processes initiated by the cloud management platform 104. During installation, the example configuration circuitry 112 is connected to the compute nodes 114a-d via cryptographic keys. An example installation operation is described in further detail below in connection with FIG. 2.

The example resource platform(s) 106 of FIG. 1 is a collection of computing resources that may be utilized to perform computing operations. The computing resources may include server computers, desktop computers, storage resources and/or network resources. Additionally or alternatively, the computing resources may include devices such as, for example, electrically controllable devices, processor controllable devices, network devices, storage devices, Internet of Things devices, or any device that can be managed by a resource manager. In some examples, the resource platform(s) 106 includes computing resources of a computing environment(s) such as, for example, a cloud computing environment. In other examples, the resource platform(s) 106 may include any combination of software resources and hardware resources. The example resource platform(s) 106 is virtualized and supports integration of virtual computing resources with hardware resources. In some examples, multiple and/or separate resource platforms 106 may be used for development, testing, staging, and/or production. The example resource platform 106 includes example compute nodes 114a-d, an example manager(s) 116, an example host(s) 118, and an example physical resource(s) 120.

The example compute nodes 114a-d are computing resources that may execute operations within the example computing environment 100. The example compute nodes 114a-d are illustrated as virtual computing resources managed by the example manager 116 (e.g., a hypervisor) executing within the example host 118 (e.g., an operating system) on the example physical resources 120. The example compute nodes 114a-d may, alternatively, be any combination of physical and virtual computing resources. For example, the compute nodes 114a-d may be any combination of virtual machines, containers, and physical computing resources.

Virtual machines operate with their own guest operating system on a host (e.g., the example host 118) using resources of the host virtualized by virtualization software (e.g., a hypervisor, virtual machine monitor, etc.) (e.g., the example manager 116). Numerous virtual machines can run on a single computer or processor system in a logically separated environment (e.g., separated from one another). A virtual machine can execute instances of applications and/or programs separate from application and/or program instances executed by other virtual machines on the same computer.

In some examples, containers are virtual constructs that run on top of a host operating system (e.g., the example compute nodes 114a-d executing within the example host 118) without the need for a hypervisor or a separate guest operating system. Containers can provide multiple execution environments within an operating system. Like virtual machines, containers also logically separate their contents (e.g., applications and/or programs) from one another, and numerous containers can run on a single computer or processor system. In some examples, utilizing containers, a host operating system uses namespaces to isolate containers from each other to provide operating-system level segregation of applications that operate within each of the different containers. For example, the container segregation may be managed by a container manager (e.g., the example manager 116) that executes with the operating system (e.g., the example compute node 114a-d executing on the example host 118). This segregation can be viewed as a form of virtualization that isolates different groups of applications that operate in different containers. In some examples, such containers are more lightweight than virtual machines. In some examples, a container OS may execute as a guest OS in a virtual machine. The example compute nodes 114a-d may host a wide variety of different applications such as, for example, an email server, a database server, a file server, a web server, etc. In the example of FIG. 1, the compute nodes 114a-d host a plugin and/or example secondary agent(s) 124a-d that communicates with the primary agent 122 of the configuration circuitry 112 and executes the commands sent by the configuration circuitry 112.

The example manager(s) 116 of FIG. 1 manages one or more of the example compute nodes 114a-d. In examples disclosed herein, the example resource platform(s) 106 may include multiple managers 116. In some examples, the example manager(s) 116 is a virtual machine manager (VMM) that instantiates virtualized hardware (e.g., virtualized storage, virtualized memory, virtualized processor(s), etc.) from underlying hardware. In other examples, the example manager(s) 116 is a container engine that enforces isolation within an operating system to isolate containers in which software is executed. As used herein, isolation means that the container engine manages a first container executing instances of applications and/or programs separate from a second (or other) container for hardware.

The example host(s) 118 of FIG. 1 is/are a native operating system(s) (OS) executing on example physical resources 120. The example host(s) 118 manages hardware of a physical machine(s). In examples disclosed herein, the example resource platform(s) 106 may include multiple hosts 118. In the illustrated example of FIG. 1, the example host(s) 118 executes the example manager 116. In some examples, certain ones of the hosts 118 may execute certain ones of the managers 116.

The example physical resource(s) 120 of FIG. 1 is a hardware component of a physical machine(s). In some examples, the physical resource(s) 120 may be a processor, a memory, a storage, a peripheral device, etc. of the physical machine(s). In examples disclosed herein, the example resource platform(s) 106 may include one or more physical resources 120. In the illustrated example of FIG. 1, the example host(s) 118 execute on the physical resource(s) 120.

The example network 108 of FIG. 1 communicatively couples computers and/or computing resources of the example computing environment 100. In the illustrated example of FIG. 1, the example network 108 is a cloud computing network that facilitates access to shared computing resources. In examples disclosed herein, information, computing resources, etc. are exchanged among the example resource platform(s) 106 and the example cloud management circuitry 104 via the example network 108. The example network 108 may be a wired network, a wireless network, a local area network, a wide area network, and/or any combination of networks.

The example client interface(s) 110 of FIG. 1 is a graphical user interface (GUI) that enables end users (e.g., administrators, software developers, etc.) to interact with the example computing environment 100. The example client interface(s) 110 enables end users to initiate compute issue(s) remediation and view graphical illustrations of compute resource performance and/or connectivity statuses between the configuration circuitry 112 and the compute nodes 114a-d. For example, when a check of connection between the primary agent 122 operating on the configuration circuitry 112 and at least one of the secondary agents(s) 124a-d operating on the compute nodes 114a-d fails, the example cloud management circuitry 104 may transmit information to be displayed on the example client interface(s) 110 regarding the failure. The information may include which compute node is disconnected and/or has failed, what operation the compute node 114a-d was executing, what version the compute node 114a-d is operating on, a state of the compute node 114a-d, etc. In examples disclosed herein, an end user(s) may rectify the connectivity issues via interactions with the example client interface(s) 110. For example, the end user(s) may select a rectify option using the client interface(s) 110 to reconnect and/or reestablish connectivity between the secondary agent(s) 124a-d and the primary agent 122. In some examples, when more than one secondary agent(s) 124a-d of the compute node(s) 114a-d is disconnected, the user(s) is/are provided with an option to rectify all of the connections via the client interface 110. In some examples, such a rectification can occur simultaneously if the cloud accounts associated with the compute nodes 114a-d have the same credentials. In some examples, the end user(s) may interact with the client interface(s) 110 to perform other operations relating to the compute node 114a-d. For example, an end user(s) may create and configure new operations, configure functions of adapters, configure one or more agents (e.g., an agent that runs on an end user device to interface with a server management software (e.g., vCenter®) corresponding to the customer infrastructure of the end user drive) via the example client interface(s) 110). In some examples, another component of the system may install and execute the new action adapters to resolve computing issues in the example resource platform(s) 106 and/or to perform the actions when requested by an end user. In some examples, the client interface(s) 110 may be presented on any type(s) of display device such as, for example, a touch screen, a liquid crystal display (LCD), a light emitting diode (LED), etc. In examples disclosed herein, the example computing environment 100 may include one or more client interfaces 110.

In FIG. 1, the example cloud proxy 102 includes a number of cryptographic keys (e.g., primary private key, primary public key, secondary private key, and secondary public key) that are used to establish a connection between the primary agent 122 of the configuration circuitry 112 and the secondary agent(s) 124a-d of the compute node(s) 114a-d, with respect to the application monitoring service. For example, the cloud management circuitry 104 generates a bootstrap bundle, which is a file including certificates and keys that can be used to install and connect primary and secondary agents at the cloud proxy 102 and at the compute node(s) 114a-d. In some examples, the cloud management circuitry 104 generates the bootstrap bundle in response to a notification from the client interface(s) 110 to trigger installation of primary and secondary agents. The cloud management circuitry 104 provides the secondary private key, the secondary public key, and the primary public key to the compute node(s) 114a-d. When a secondary agent 124a-d is installed on the compute node(s) 114a-d and a primary agent 122 is installed on the configuration circuitry 112, the secondary agent 124a-d utilizes the secondary private key and the primary public key to establish connectivity with the primary agent 122. In some examples, the keys are used for authorization between the primary agent 122 and the secondary agent 124a-d. In some examples, the keys are pre-set and/or pre-configured. For example, during installation, the secondary agent(s) 124a-d may be configured with the keys. In some examples, however, a user and/or administrator will have to manually accept an incoming request from the primary agent 122 to authenticate and approve communication with the secondary agent(s) 124a-d.

There are many components (e.g., compute nodes(s) 114a-d, manager(s) 116, hos(s) 118, physical resource(s) 120, keys, configuration circuitry 112, etc.) involved in executing the application monitoring service that communicate over the example network 108. Any issues with any of the components would disrupt the connectivity between the primary agent 122 and secondary agent(s) 124a-d and, thus, would disrupt jobs, tasks, activities, etc., planned by the user and/or administrator. Conventionally, the cloud management circuitry 104 has not provided users with an option to show the status of the connectivity. However, in examples disclosed herein, the cloud management circuitry 104 implements methods and apparatus to not only provide the status of the connectivity between the primary agent 122 and the secondary agent 124a-d, but also an option to rectify the connection when a connectivity issue is identified.

FIG. 2 is an example data flow diagram 200 illustrating an example installation process of a primary agent (e.g., primary agent 122 of FIG. 1) and a secondary agent (e.g., secondary agent(s) 124a-d). The example data flow diagram 200 includes the example cloud management circuitry 104, the example cloud proxy 102, and the example compute node(s) 114a-d. The example cloud management circuitry 104, the example cloud proxy 102, and the example compute node(s) 114a-d execute example processes (e.g., steps) 202-216 to install the primary and secondary agents and to start the application monitoring service.

In the example data flow diagram 200, the example cloud management circuitry 104 executes a first step 202 that triggers an agent install. For example, the cloud management circuitry 104 may receive an instruction via the client interface(s) 110 of FIG. 1, an API, and/or a script indicative to install a secondary agent (e.g., secondary agent(s) 124a-d) at compute node(s) 114a-d. In some examples, a user and/or administrator may request, through the client interface(s) 110, to install the secondary agent. In some examples, the cloud management circuitry 104 triggers an agent install by notifying the cloud proxy 102 and providing the cloud proxy 102 with a bootstrap bundle. In some examples, the bootstrap bundle is a file containing certificates and keys that are to be used to install the secondary agent.

In the example data flow diagram 200, the example cloud proxy 102 executes a second step 204 that installs the secondary agent with input plugins to collect operating system metrics. As used herein, the secondary agent is an application monitoring agent installed on a compute node (e.g., compute node(s) 114a-d) that is controlled and/or receives instructions from a primary agent. To execute the second step 204, the cloud proxy 102 downloads the bootstrap bundle and provides the certificates and keys to the compute node(s) 114a-d to install the secondary agent.

In the example data flow diagram 200, the example cloud proxy 102 executes a third step 206 that installs the primary agent (e.g., primary agent 122 of FIG. 1). For example, the cloud proxy 102 installs the primary agent at the configuration circuitry 112 of FIG. 1. As such, the configuration circuitry 112 implements the primary agent and uses the primary agent to communicate with the secondary agent. In some examples, during the third step 206, the cloud proxy 102 notifies the compute node(s) 114a-d to configure the connection between the primary agent and the secondary agent after the secondary agent is installed. In some examples, there is already a primary agent installed at the configuration circuitry 112 and, thus, the cloud proxy 102 notifies the compute node(s) 114a-d to configure the connection between the primary agent and the secondary agent at the third step 206.

In the data flow diagram 200, the example compute node(s) 114a-d execute a fourth step 208 that runs (e.g., executes, starts, etc.) a test of the monitoring service to find a number of metrics per collection cycle. For example, the compute node(s) 114a-d may trigger the secondary agent, in response to an installation request from the cloud proxy 102, to collect metrics corresponding to applications running at the compute node(s) 114a-d. In some examples, this test assists the configuration circuitry 112 to configure the secondary agent. For example, the secondary agent is initially not informed on what metrics are to be collected and how many metrics are to be collected. Therefore, the compute node(s) 114a-d execute the test to configure buffer(s) and/or memory at the configuration circuitry 112 and/or at the cloud management circuitry 104 to store a particular size (e.g., bytes) of metrics. As used herein, metrics may include CPU metrics (e.g., idle measurement, busy measurement, processing measurement, etc.), memory metrics (e.g., total bytes, percentage of memory used, percentage of unused memory available for processes, etc.), disk and partition metrics (e.g., average input/output (TO) utilization, writes per second, etc.), load metrics (e.g., CPU load, presented as an average over the last 1 minute, 5 minutes, etc.), and/or network metrics (e.g., volume of data received by all monitored network devices, number of packets received, number of outgoing packets, etc.). Any other type of available metrics may be collected by the secondary agent and provided to the cloud management circuitry 104.

In the example data flow diagram 200, the example compute node(s) 114a-d executes a fifth step 210 that updates a metric buffer limit value based on the test run of the monitoring service. For example, the secondary agent, hosted by the compute node(s) 114a-d, identify a number of metrics to be stored in a buffer of the compute node(s) 114a-d and update the metric buffer limit value to reflect the identified number. In some examples, the metric buffer limit value is to be used to configure the secondary agent.

In the example data flow diagram 200, the example compute node(s) 114a-d execute a sixth step 212 to restart the monitoring service. For example, the secondary agent restarts the monitoring service after the metric buffer limit value is identified. In some examples, the secondary agent restarts the monitoring service because the configuration of the secondary agent changed during the fifth step 210. For example, an initial configuration of the secondary agent may have defined a metric buffer limit value as some pre-determined value, not representative of the actual amount of metrics that are to be collected. Therefore, an updated configuration of the secondary agent requires the restarting of the monitoring service to properly collect metrics from the compute node(s) 114a-d.

In the example data flow diagram 200, the example compute node(s) 114a-d executes a seventh step 214 that collects service discovery metrics and provides them to the cloud proxy 102. For example, the secondary agent collects metrics from the compute node(s) 114a-d in response to restarting the monitoring service. The secondary agent provides the metrics to the primary agent.

In the example data flow diagram 200, the example cloud proxy 102 executes an eighth step 216 that provides a list of applications discovered at the compute node(s) 114a-d to the cloud management circuitry 104. For example, the primary agent, hosted by the configuration circuitry 112, utilizes the metrics obtained from the secondary agent to determine what applications are running at the compute node(s) 114a-d. As such, the primary agent provides the list of applications to the cloud management circuitry 104 for displaying at the client interface(s) 110.

In some examples, after installation and an initial starting of the application monitoring service, the cloud management circuitry 104 can be controlled by a user and/or an administrator to perform a number of different operations, jobs, tasks, etc.

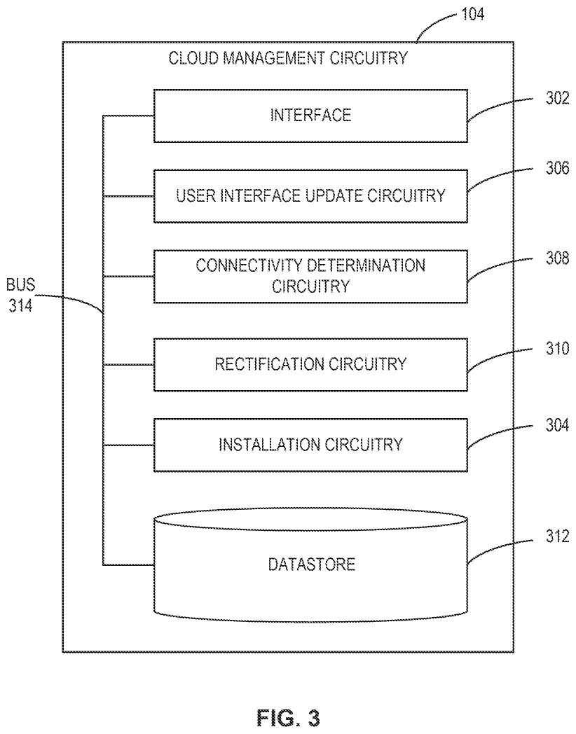

FIG. 3 is a block diagram of the example cloud management circuitry 104 of FIG. 1 to identify connectivity issues and rectify the connectivity issues. The cloud management circuitry 104 of FIG. 3 may be instantiated (e.g., creating an instance of, bring into being for any length of time, materialize, implement, etc.) by processor circuitry such as a central processing unit executing instructions. Additionally or alternatively, the cloud management circuitry 104 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

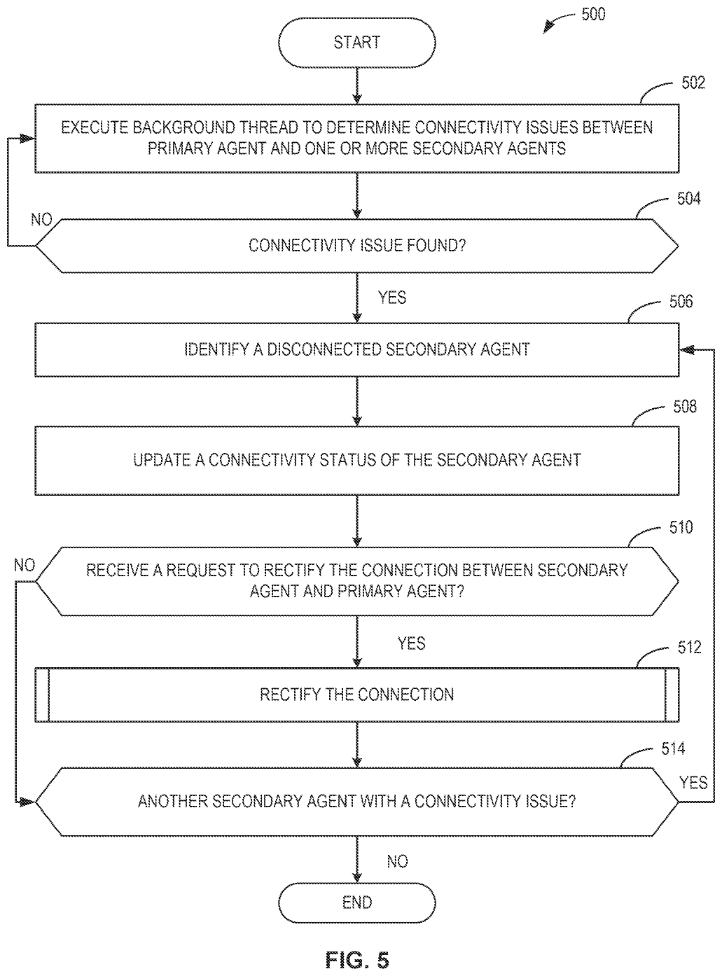

The example cloud management circuitry 104 of FIG. 3 includes an example interface 302, example installation circuitry 304, example user interface update circuitry 306, example connectivity determination circuitry 308, example rectification circuitry 310, an example datastore 312, and an example bus 314. In some examples, the cloud management circuitry 104 is instantiated by processor circuitry executing cloud management circuitry instructions and/or configured to perform operations such as those represented by the flowchart of FIGS. 5, 6, and 7.

The example interface 302 of FIG. 3 obtains (e.g., accesses, receives, etc.) and or transmits (e.g., sends, outputs, etc.) data via the example network 108. For example, the interface 302 may output and/or obtain data (e.g., jobs, processes, etc.) to perform a connectivity status check (e.g., execute background threads, transmit user credentials, instructions, etc.) to the example resource platform(s) 106 via the example configuration circuitry 112 and/or a device that implements the client interface(s) 110 of FIG. 1. Additionally, the example interface 302 may transmit alerts, tags, instructions, and/or any other information related to a cloud account and/or the application monitoring service to a user via the client interface(s) 110. In some examples, the interface 302 transmits the bootstrap bundles (e.g., files including certificates and keys) to the resource platform(s) 106 for delivery to the compute node(s) 114a-d.

The example installation circuitry 304 installs secondary agents 124a-d at the compute nodes 114a-d and connects the secondary agent(s) to the primary agent 122 installed on the example configuration circuitry 112 of FIG. 1. The example installation circuitry 304 generates sets of cryptographic keys (e.g., a primary public key, primary private key, secondary public key, and secondary private key), where each set is to be used by the compute node(s) 114a-d to establish a connection between with the primary agent 122 on the configuration circuitry 112. The example installation operation is described above in connection with FIGS. 1 and 2.

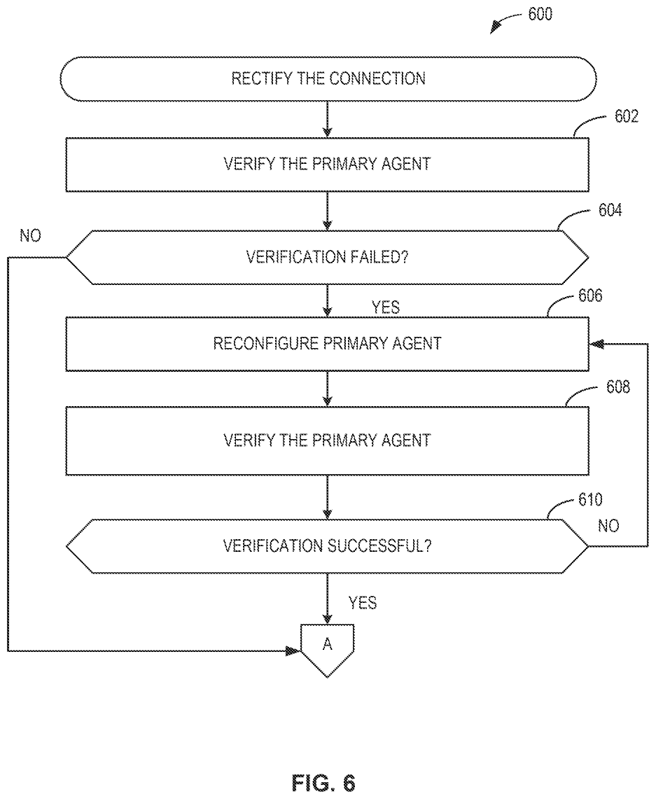

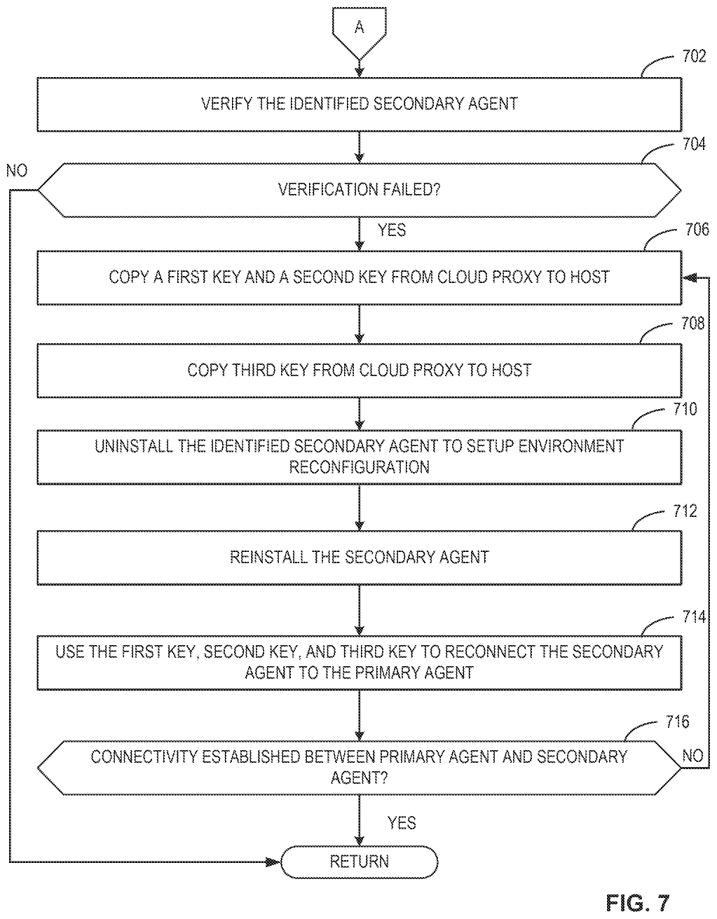

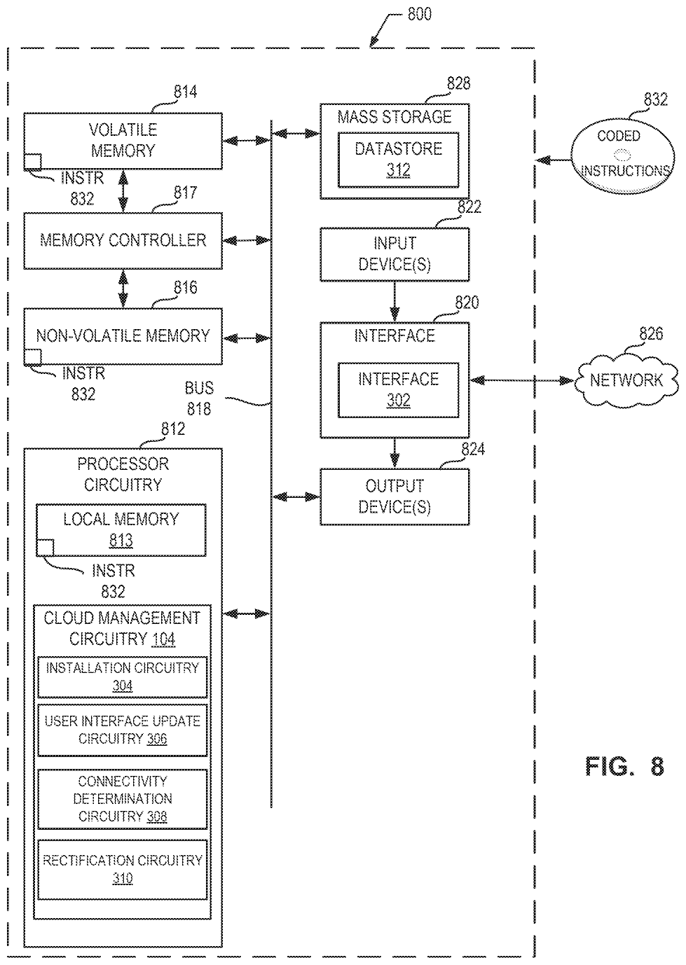

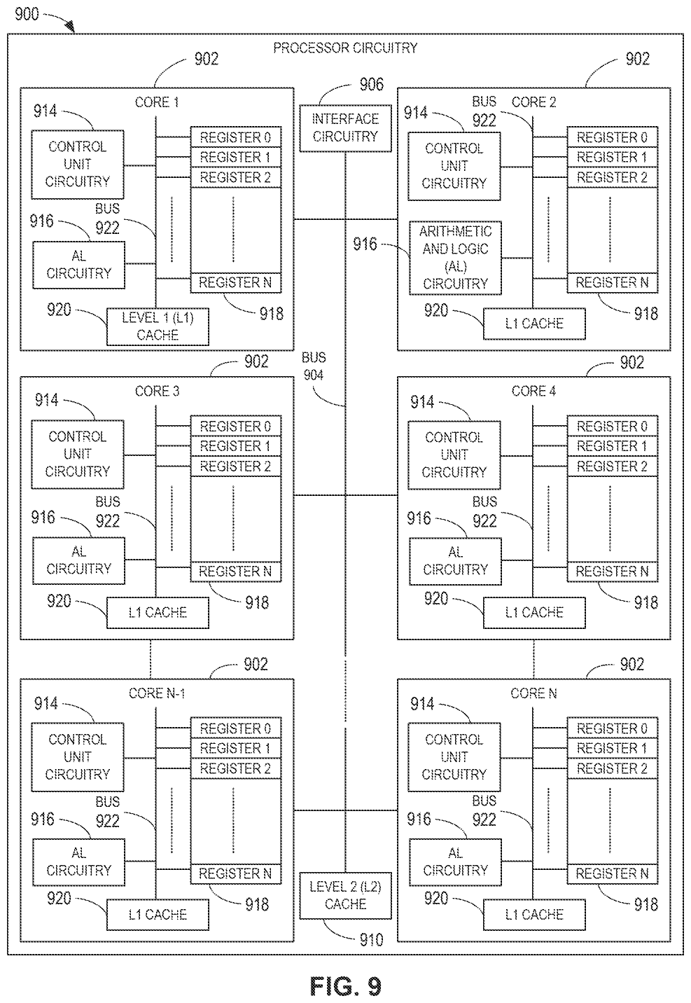

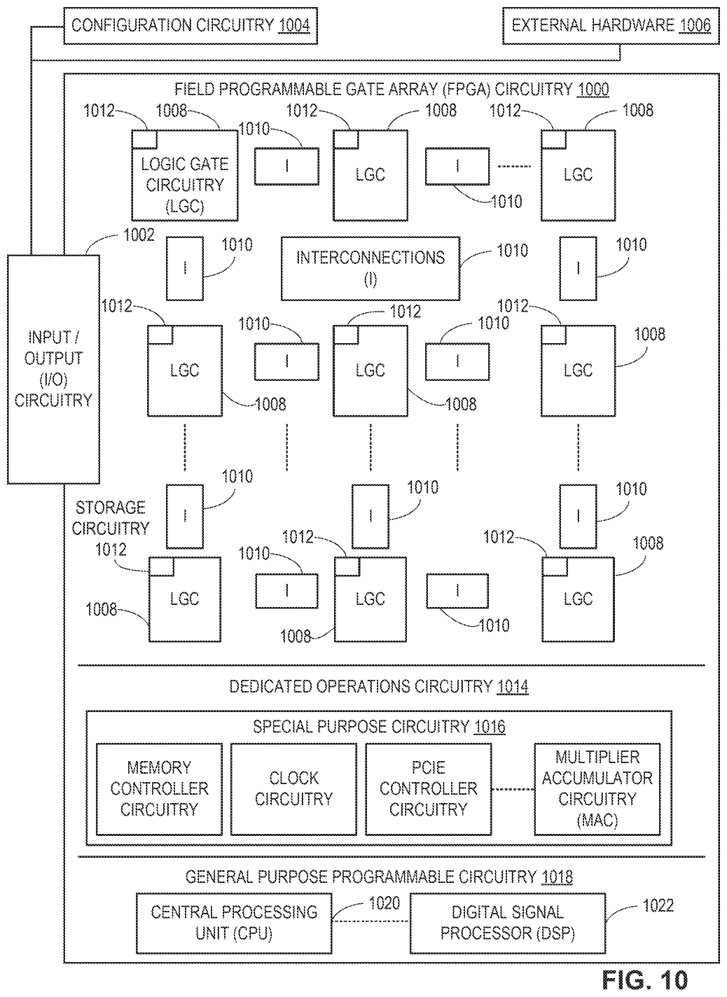

In some examples, the installation circuitry 304 includes means for installing agents. For example, the means for determining may be implemented by installation circuitry 304. In some examples, the installation circuitry 304 may be instantiated by processor circuitry such as the example processor circuitry 812 of FIG. 8. For instance, the installation circuitry 304 may be instantiated by the example microprocessor 900 of FIG. 9 executing machine executable instructions such as those implemented by at least block 606 of FIG. 6 and blocks 706, 708, 710, 712, and 714 of FIG. 7. In some examples, the installation circuitry 304 may be instantiated by hardware logic circuitry, which may be implemented by an ASIC, XPU, or the FPGA circuitry 1000 of FIG. 10 structured to perform operations corresponding to the machine readable instructions. Additionally or alternatively, the installation circuitry 304 may be instantiated by any other combination of hardware, software, and/or firmware. For example, the installation circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example user interface update circuitry 306 of FIG. 3 updates connectivity status of compute nodes 114a-d. For example, the user interface circuitry 306 provides the client interface(s) 110 with instructions to display certain information to the user and/or administrator. In some examples, the user interface update circuitry 306 obtains information about applications running on the compute node(s) 114a-d and notifies the client interface(s) 110 to display the information. In some examples, the user interface circuitry 306 obtains data from the datastore 312. For example, the user interface circuitry 306 obtains connectivity status information, application monitoring information, etc., from the datastore 312.

In some examples, the user interface update circuitry 306 includes means for updating user interface(s) and/or means for instructing user interface(s) to display connectivity statuses. For example, the means for updating may be implemented by user interface update circuitry 306. In some examples, the user interface update circuitry 306 may be instantiated by processor circuitry such as the example processor circuitry 812 of FIG. 8. For instance, the user interface update circuitry 306 may be instantiated by the example microprocessor 900 of FIG. 9 executing machine executable instructions such as those implemented by at least block 508 of FIG. 5. In some examples, the user interface update circuitry 306 may be instantiated by hardware logic circuitry, which may be implemented by an ASIC, XPU, or the FPGA circuitry 1000 of FIG. 10 structured to perform operations corresponding to the machine readable instructions. Additionally or alternatively, the user interface update circuitry 306 may be instantiated by any other combination of hardware, software, and/or firmware. For example, the user interface update circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example connectivity determination circuitry 308 of FIG. 3 periodically and/or aperiodically checks the connection between a primary agent 122 and one or more secondary agents 124a-d. The example connectivity determination circuitry 308 executes a background thread. In some examples, the background thread includes instructions that request the primary agent 122, running on the configuration circuitry 112, to execute a command to check the connectivity for every secondary agent 124a-d running on the compute node(s) 114a-d. For example, the connectivity determination circuitry 308 may trigger the background thread, which causes the primary agent 122 running on the configuration circuitry 112 to execute a command that checks the connectivity between the primary agent 122 and the secondary agent(s) 124a-d. In some examples, the connectivity determination circuitry 308 triggers the background thread periodically (e.g., every 10 minutes, once an hour, once a day, etc.). In some examples, the connectivity determination circuitry 308 triggers the background thread aperiodically (e.g., at no set time interval). In some examples, the connectivity determination circuitry 308 receives responses from the secondary agent(s) 124a-d via the configuration circuitry 112. In such examples, the connectivity determination circuitry 308 populates the datastore 312 with the responses. In some examples, whether the response indicates that there is or not a connectivity issue, the connectivity determination circuitry 308 notifies the user interface update circuitry 306 to update the connectivity status.

In some examples, the connectivity determination circuitry 308 includes means for identifying a connectivity issue and/or means for determining connectivity statuses. For example, the means for identifying may be implemented by connectivity determination circuitry 308. In some examples, the connectivity determination circuitry 308 may be instantiated by processor circuitry such as the example processor circuitry 812 of FIG. 8. For instance, the connectivity determination circuitry 308 may be instantiated by the example microprocessor 900 of FIG. 9 executing machine executable instructions such as those implemented by at least blocks 502, 504, 506, and 514 of FIG. 5 and block 716 of FIG. 7. In some examples, the connectivity determination circuitry 308 may be instantiated by hardware logic circuitry, which may be implemented by an ASIC, XPU, or the FPGA circuitry 1000 of FIG. 10 structured to perform operations corresponding to the machine readable instructions. Additionally or alternatively, the connectivity determination circuitry 308 may be instantiated by any other combination of hardware, software, and/or firmware. For example, the connectivity determination circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example rectification circuitry 310 of FIG. 3 resolves and/or rectifies a connectivity issue between a primary agent 122 and a secondary agent(s) 124a-d. The example rectification circuitry 310 is in communication with the example interface 302, via an example bus 314, to receive instructions to rectify a connection between the primary agent 122 and a particular secondary agent 124a-d. For example, a user and/or administrator may utilize the client interface(s) 110 to command the rectification circuitry 310 to reestablish a connection that has been disabled, terminated, etc. In some examples, the rectification circuitry 310 replicates the installation process (described above in connection with FIG. 2) to reestablish a connection between a primary agent 122 and secondary agent(s) 124a-d.

In some examples, the rectification circuitry 310 implements a two-part process to rectify and/or resolve a connectivity issue. The first part of the two-part process includes rectifying the primary agent 122. For example, the rectification circuitry 310 ensures the primary agent 122 is operational (e.g., up and running) at the configuration circuitry 112. In some examples, if there is an issue with the primary agent 122, the rectification circuitry 310 restarts and/or reconfigures the primary agent 122. The example rectification circuitry 310 verifies the operating state of the primary agent 122 before proceeding to the second part of the two-part process. The second part of the two-part process includes rectifying the secondary agent(s) 124a-d. For example, the rectification circuitry 310 ensures that the secondary agent(s) 124a-d is operational (e.g., up and running) at the compute node(s) 114a-d. In some examples, the rectification circuitry 310 reconfigures the authentication between the secondary agent(s) 124a-d and the primary agent 122. For example, the rectification circuitry 310 may reconfigure the cryptographic keys (e.g., the secondary private key, the secondary public key, and the primary public key), uninstall the secondary agent(s) 124a-d, reinstall the secondary agent(s) 124a-d, and utilize the reconfigured keys to restart the operation of the secondary agent(s) 124a-d. In some examples, upon restart, the secondary agent(s) 124a-d reconnect to the primary agent 122. In some examples, the rectification circuitry 310 reconfigures the cryptographic keys because the keys are corrupted. In some examples, the rectification circuitry 310 identifies which keys are corrupted. For example, the rectification circuitry 310 determines whether the primary keys are corrupted and/or whether the secondary keys are corrupted. In some examples, the rectification circuitry 310 could determine that a file including the primary keys is unreadable (e.g., not accessible). In some examples, the rectification circuitry 310 could determine that a file including the secondary keys is unreadable. In some examples, the rectification circuitry 310 reconfigures only the primary public key in response to the primary public key being corrupted. In some examples, the rectification circuitry 310 reconfigures only the secondary public key and the secondary private key in response to the secondary keys being corrupted.

In some examples, the rectification circuitry 310 requests credentials (e.g., user credentials) prior to proceeding with the two-part rectification process. In some examples, if the rectification circuitry 310 identifies that more than one secondary agent 124a-d has a connectivity issue, the rectification circuitry 310 determines whether each of the identified secondary agent(s) 124a-d use the same user credentials. For example, each of the secondary agent(s) 124a-d may be installed on compute node(s) 114a-d having the same cloud account and, thus, the same credentials. In some examples, the rectification circuitry 310 simultaneously rectifies each of the identified secondary agent(s) 124a-d in response to each of the identified secondary agent(s) 124a-d having the same user credentials. In some examples, a user and/or administrator can select all of the compute node(s) 114a-d hosting secondary agent(s) 124a-d that have connectivity issues and request that the rectification circuitry 310 resolve the connection at the same time.

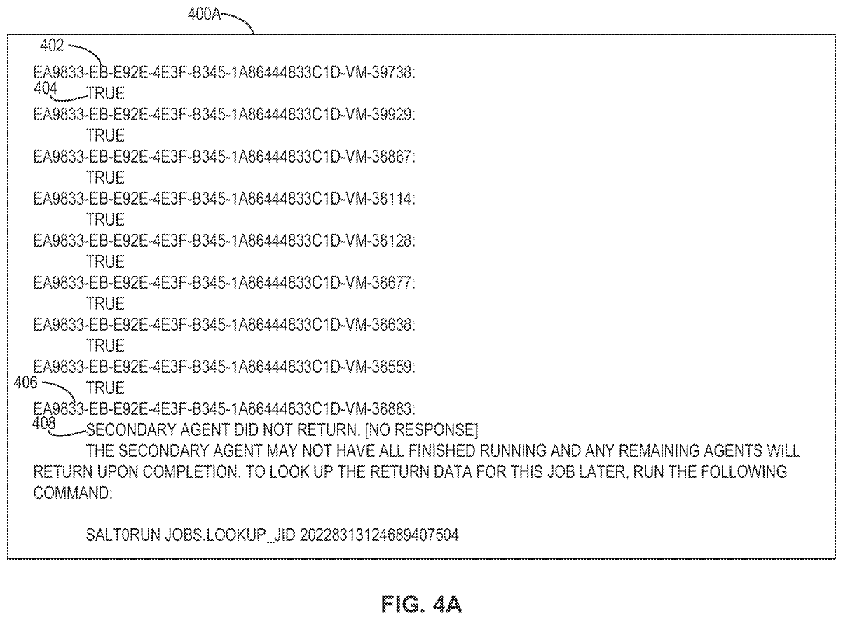

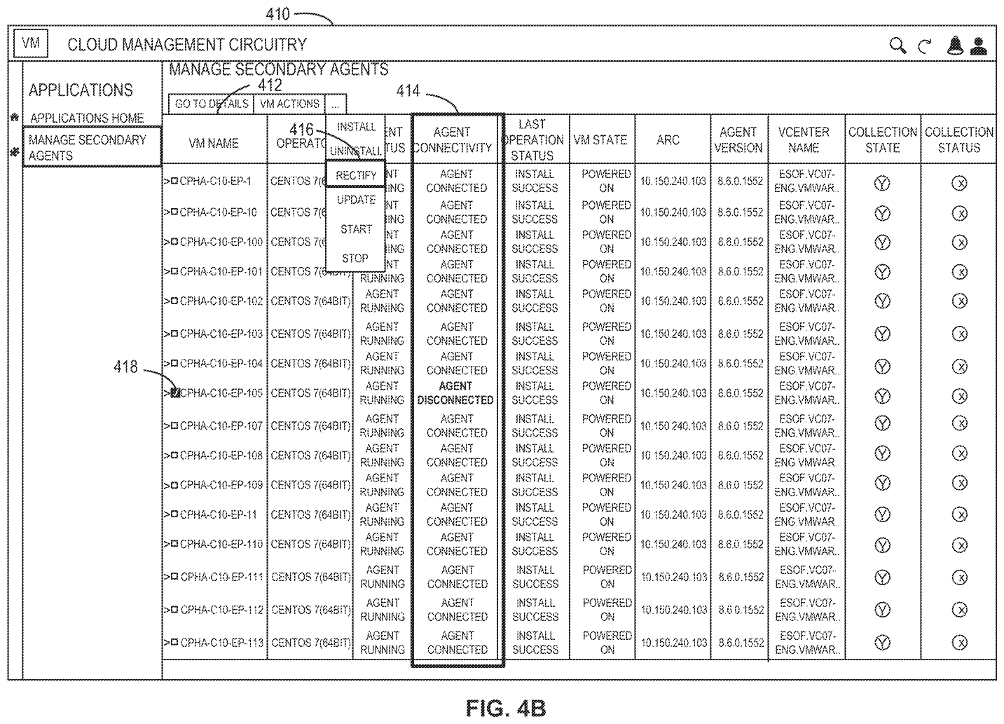

In some examples, the rectification circuitry 310 notifies the user interface update circuitry 306 when a connection between the primary agent 122 and the identified secondary agent(s) 124a-d has been reestablished (e.g., rectified). In some examples, the user interface update circuitry 306 instructs the client interface(s) 110 to display the status of the identified secondary agent(s) 1240a-d verified connection. An example user interface (e.g., client interface 110) is shown and described in further detail below in connection with FIGS. 4A and 4B.

In some examples, the rectification circuitry 310 includes means for rectifying a connectivity issue, means for resolving a connectivity issue, and/or means for reestablishing a connection between a primary agent and secondary agent. For example, the means for rectifying may be implemented by rectification circuitry 310. In some examples, the rectification circuitry 310 may be instantiated by processor circuitry such as the example processor circuitry 812 of FIG. 8. For instance, the rectification circuitry 310 may be instantiated by the example microprocessor 900 of FIG. 9 executing machine executable instructions such as those implemented by at least blocks 510 and 512 of FIG. 5, blocks 602, 604, 608, and 610 of FIG. 6, and blocks 702, 704, 706, 708, and 716 of FIG. 7. In some examples, the rectification circuitry 310 may be instantiated by hardware logic circuitry, which may be implemented by an ASIC, XPU, or the FPGA circuitry 1000 of FIG. 10 structured to perform operations corresponding to the machine readable instructions. Additionally or alternatively, the rectification circuitry 310 may be instantiated by any other combination of hardware, software, and/or firmware. For example, the rectification circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example datastore 312 of FIG. 3 stores metric data, connectivity status data, operational data, and cryptographic keys and certificates. In some examples, the datastore 312 can be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 312 can additionally or alternatively be implemented by one or more double data rate (DDR) memories, such as DDR, DDR2, DDR3, DDR4, mobile DDR (mDDR), etc. The datastore 312 can additionally or alternatively be implemented by one or more mass storage devices such as hard disk drive(s), compact disk drive(s), digital versatile disk drive(s), solid-state disk drive(s), etc. While in the illustrated example the datastore 312 is illustrated as a single datastore, the datastore 312 can be implemented by any number and/or type(s) of datastores. Furthermore, the data stored in the datastore 312 can be in any data format such as, for example, binary data, comma delimited data, tab delimited data, structured query language (SQL) structures, etc.

FIG. 4A illustrates an example first user interface 400 to display commands and responses of the example secondary agent(s) 124a-d of FIG. 1. The example first user interface 400 is a command-line interface (CLI) and may be implemented by the client interface(s) 110. For example, the first user interface 400 is used to display the background thread, triggered by the example connectivity determination circuitry 308 of FIG. 3, and the results (e.g., responses from the compute node(s) 114a-d) of the background thread. The example first user interface 400 includes a first command 402, a first response 404, a second command 406, and a second response 408.

The example first command 402 instructs the first compute node 114a to check the connectivity status of the first secondary agent 124a. In some examples, the connectivity determination circuitry 308 instructs the configuration circuitry 112 to execute the first command 402. The example first response 404 illustrates that the first secondary agent 124a has a stable connection by displaying the value “TRUE.” For example, the first response 404 indicates that no issues exist with the first secondary agent 124a.

The example second command 406 instructs the fourth compute node 114d to check the connectivity status of the fourth secondary agent 124d. The example second response 408 illustrates that the fourth secondary agent 124d has a connectivity issue by displaying the text “SECONDARY AGENT DID NOT RETURN.” For example, the connectivity determination circuitry 308 did not receive a valid response from the fourth compute node 114d. As such, there is a connectivity issue between the fourth secondary agent 124d and the primary agent 122.

FIG. 4B illustrates an example second user interface 410 to display application information corresponding to example secondary agents (e.g., secondary agents 124a-d of FIG. 1). In some examples, the second user interface 410 is implemented by the client interface(s) 110 of FIG. 1. In some examples, the second user interface 410 enables a user and/or administrator to interact with the secondary agents. For example, the second user interface 410 provides a user and/or administrator with the ability to view operational statuses of secondary agents, install and/or add secondary agents, instantiate and/or add compute nodes (e.g., virtual machines), update versions the secondary agents are operating at, uninstall secondary agents, start operation of the secondary agents, stop operation of the secondary agents, etc. The example second user interface 410 includes an example first column 412, an example second column 414, and an example action option 416.

The example first column 412 depicts compute node names. For example, each compute node (e.g., compute node(s) 114a-d) the is given and/or provided with a name during instantiation. In some examples, the connectivity determination circuitry 308 of FIG. 3 utilizes the name of the compute node in the command that requests a connectivity status update. For example, the connectivity determination circuitry 308 requires the name of the compute node in order to check whether the secondary agent installed on that compute node is connected to the primary agent. In some examples, the user interface update circuitry 306 of FIG. 3 provides the client interface(s) 110 with the names of the compute nodes.

The example second column 414 depicts agent connectivity statuses. The example second column 414 enables a user and/or an administrator to view the connectivity status of the secondary agent running on the respective compute node and take an action based on the status indicated in the example second column 414. In some examples, the user interface update circuitry 306 provides the second user interface 410 with the status information and instructs the second user interface 410 to update the second column 414 based on the status information.

The example action option 416 is a “RECTIFY” option that instructs the example rectification circuitry 310 to rectify the connection of a selected compute node. For example, a first virtual machine (VM) 418 has a secondary agent that is disconnected, depicted in the second column 414. In the example second user interface 410, a user and/or administrator has selected the VM 418 and interacted with the action option 416 “RECTIFY.” The example rectification circuitry 310 obtains this instruction, along with the name of the VM 418, and executes the two-part process to reestablish the connectivity between the secondary agent and the primary agent.

While an example manner of implementing the cloud management circuitry 104 of FIG. 1 is illustrated in FIG. 3, one or more of the elements, processes, and/or devices illustrated in FIG. 3 may be combined, divided, re-arranged, omitted, eliminated, and/or implemented in any other way. Further, the example interface 302, the example installation circuitry 304, the example user interface update circuitry 306, the example connectivity determination circuitry 308, the example rectification circuitry 310, the example datastore 312, and/or, more generally, the example cloud management circuitry 104 of FIG. 1, may be implemented by hardware alone or by hardware in combination with software and/or firmware. Thus, for example, any of the example interface 302, the example installation circuitry 304, the example user interface update circuitry 306, the example connectivity determination circuitry 308, the example rectification circuitry 310, the example datastore 312, and/or, more generally, the example cloud management circuitry 104, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example cloud management circuitry 104 of FIG. 1 may include one or more elements, processes, and/or devices in addition to, or instead of, those illustrated in FIG. 3, and/or may include more than one of any or all of the illustrated elements, processes and devices.

Flowcharts representative of example machine readable instructions, which may be executed to configure processor circuitry to implement the cloud management circuitry 104 of FIGS. 1 and 3, are shown in FIG. 3. The machine readable instructions may be one or more executable programs or portion(s) of an executable program for execution by processor circuitry, such as the processor circuitry 812 shown in the example processor platform 800 discussed below in connection with FIG. 8 and/or the example processor circuitry discussed below in connection with FIGS. 9 and/or 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 3, many other methods of implementing the example apparatus 50 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to identify a connectivity issue of a secondary agent and resolve the issue. The machine readable instructions and/or the operations 500 of FIG. 5 begin at block 502, at which the example connectivity determination circuitry 308 (FIG. 3) executes a background thread to determine connectivity issues between primary agent and one or more secondary agents. For example, the connectivity determination circuitry 308 triggers a background thread to be executed by the primary agent (e.g., primary agent 122 of FIG. 1) at the configuration circuitry 112 (FIG. 1). In some examples, the primary agent sends commands (e.g., the first command 402 of FIG. 4, the second command 406 of FIG. 4, etc.) to the one or more secondary agents (e.g., secondary agent(s) 124a-d), requesting a response (e.g., the first response 404 of FIG. 1 and/or the second response 408 of FIG. 4). In some examples, the primary agent and/or the configuration circuitry 112 provides the connectivity determination circuitry 308 with the response(s).

The example connectivity determination circuitry 308 determines whether a connectivity issue was found (block 504). For example, the connectivity determination circuitry 308 reads (e.g., analyzes, processes, etc.) the responses from the one or more secondary agents, provided by the primary agent, to determine whether a connection between one or more secondary agents and the primary agent has been terminated, failed, etc.

In some examples, when the connectivity determination circuitry 308 determines that no connectivity issue has been found (e.g., block 504 returns a value NO), control returns to block 502. For example, no further analysis is required if all secondary agents are fully connected to the primary agent. In some examples, the connectivity determination circuitry 308 notifies the user interface update circuitry 306 (FIG. 3) to update the client interface(s) 110 (FIG. 1). For example, the connectivity determination circuitry 308 instructs the client interface(s) 110, via the network 108 (FIG. 1), to update the second column 414 (FIG. 4B) of the second user interface 410 (FIG. 4B).

In some examples, when the connectivity determination circuitry 308 determines that a connectivity issue has been found (e.g., block 504 returns a value YES), the example connectivity determination circuitry 308 identifies the disconnected secondary agent (block 506). For example, the connectivity determination circuitry 308 identifies a name of the compute node(s) 114a-d, hosting the secondary agent(s) 124a-d that has been disconnected from the primary agent 122.

The example user interface update circuitry 306 updates a connectivity status of the secondary agent (block 508). For example, the user interface update circuitry 306 is notified, by the connectivity determination circuitry 308, that a particular secondary agent has been disconnected from the primary agent. In some examples, the user interface circuitry 306 obtains an instruction from the client interface(s) 110 to rectify the failed connection. In some examples, the user interface update circuitry 306 instructs the client interface(s) 110 to update the second column 414 of the second user interface 410 to indicate which secondary agent has been disconnected. For example, the second column 414 is to display “AGENT DISCONNECTED” next to and/or associated with the identified secondary agent in response to receiving an instruction from the user interface update circuitry 306.

The example rectification circuitry 310 (FIG. 3) determines whether a request to rectify the connection between the secondary agent and the primary agent has been received (block 510). In some examples, the interface 302 (FIG. 3) determines whether a request to rectify the connection between the secondary agent and the primary agent has been received. In some examples, the client interface(s) 110 send the rectification circuitry 310 an instruction corresponding to an action to take on a compute node 114a-d. In such an example, the instruction can be in sent in response to a user and/or an administrator viewing the secondary agent's connectivity status. In some examples, the action option 416 (FIG. 4B) is selected to rectify the connection of the secondary agent.

In some examples, when the rectification circuitry 310 receives a request to rectify the connection (e.g., block 510 returns a value YES), the rectification circuitry 310 rectifies the connection (block 512). For example, the rectification circuitry 310 executes a two-part process, described below in connection with FIGS. 6 and 7, to reestablish the connection between the identified secondary agent and the primary agent.

The example connectivity determination circuitry 308 determines whether there is another secondary agent with a connectivity issue (block 514). For example, in response to the rectification circuitry 310 rectifying the connection between the identified secondary agent and the primary agent, the connectivity determination circuitry 308 can move on to identify other connectivity issues.

In some examples, when the rectification circuitry 310 does not receive a request to rectify the connection (e.g., block 510 returns a value NO), the connectivity determination circuitry 308 determines whether there is another secondary agent with a connectivity issue (block 514). For example, a user and/or administrator may not utilize the secondary agent that has a failed connection and, thus, may not take an action to rectify it. In such an example, the connectivity determination circuitry 308 continues to determine whether there are issues with other secondary agents.

The example operations 500 ends when the connectivity determination circuitry 308 determines that there are no connectivity issues with the secondary agents. In some examples, the operations 500 restart when the connectivity determination circuitry 308 triggers an execution of the background thread.

FIG. 6 is a flowchart representative of example machine readable instructions and/or example operations 600 that may be executed and/or instantiated by processor circuitry to verify and/or reconfigure a state of primary agent to complete the first part of the two-part process to rectify the secondary agent. The machine readable instructions and/or the operations 600 of FIG. 6 begin at block 602, at which the rectification circuitry 310 verifies the primary agent 122. For example, the rectification circuitry 310 determines an operating state of the primary agent 122 to verify the primary agent 122. In some examples, the rectification circuitry 310 determines a state of the configuration circuitry 112 to verify the primary agent 122. For example, if there is an issue with the configuration circuitry 112, then there may be an issue with the primary agent 122.

The example rectification circuitry 310 determines whether the verification failed (block 604). For example, the rectification circuitry 310 determines whether any issues were identified with the primary agent and/or the configuration circuitry 112. In some examples, an issue with the primary agent 122 and/or the configuration circuitry 112 is identified when all of the secondary agents 124a-d associated with the primary agent 122 are not connected to the primary agent 122. In some examples, an issue with the primary agent 122 and/or the configuration circuitry 112 is identified when a child service (e.g., a program executed by the primary agent 122) of the primary agent 122 is not in an operational state.

In some examples, if the rectification circuitry 310 determines that the verification has failed, the installation circuitry 304 (FIG. 3) reconfigures the primary agent 122 (block 606). For example, the rectification circuitry 310 notifies the installation circuitry 304 that the primary agent 122 is to be reconfigured. In some examples, to reconfigure the primary agent 122, the installation circuitry 304 is to uninstall and reinstall the primary agent 122 on the configuration circuitry 112.

The example rectification circuitry 310 verifies the primary agent 122 (block 608). For example, after the installation circuitry 304 reconfigures the primary agent 122, the rectification circuitry 310 determines whether the primary agent 122 is operational. In some examples, the rectification circuitry 310 determines the primary agent 122 is operational by sending a test command to the primary agent 122.

The example rectification circuitry 310 determines whether the verification was successful (block 610). For example, the rectification circuitry 310 determines whether the primary agent 122 returned a valid or invalid response to the test command. Additionally and/or alternatively, the rectification circuitry 310 can utilize any methods, algorithms, processes, to verify the state of the primary agent 122.

In some examples, if the rectification circuitry 310 determines that the verification was not successful (e.g., block 610 returns a value NO), control returns to block 606. For example, the rectification circuitry 310 attempts to reconfigure the primary agent 122 until the rectification circuitry 310 determines a successful state of the primary agent 122. In some examples, the rectification circuitry 310 instructs the installation circuitry 304 to utilize different steps, processes, etc., to ensure a successful reconfiguration of the primary agent 122.

In some examples, if the rectification circuitry 310 determines that the verification was successful (e.g., block 610 returns a value YES), control turns to the second part of the two-part process, in FIG. 7. In some examples, if the rectification circuitry 310, at block 604, determines that the primary agent 122 does not have any issues, is operational, etc., then control turns to the second part of the two-part process, in FIG. 7.

FIG. 7 is a flowchart representative of example machine readable instructions and/or example operations 700 that may be executed and/or instantiated by processor circuitry to verify and/or reconfigure a state of the secondary agent to complete the second part of the two-part process to rectify the secondary agent. The machine readable instructions and/or the operations 700 of FIG. 7 begin at block 702, at which the rectification circuitry 310 verifies the identified secondary agent 124a-d. For example, the rectification circuitry 310 instructs the primary agent 122 to send a test command to the secondary agent 124a-d that was identified as having a terminated and/or failed connection. In some examples, the test command requests that the secondary agent 124a-d respond with an indication of operation (e.g., metrics collection status, metrics, etc.). In some examples, the rectification circuitry 310 sends a command to the compute node(s) 114a-d hosting the identified secondary agent 124a-d to verify the operation of the secondary agent(s) 124a-d.

The example rectification circuitry 310 determines whether the verification failed (block 704). For example, the rectification circuitry 310 determines whether the identified secondary agent(s) 124a-d has provided a valid or invalid response to the test command.

In some examples, when the rectification circuitry 310 determines that the verification did not fail (e.g., block 704 returns a value NO), control returns to block 514 of FIG. 5. For example, connectivity was established in response to reconfiguring the primary agent 122 during operations 600. Therefore, the example rectification circuitry 310 does not need to reconfigure the secondary agent(s) 124a-d.

In some examples, when the rectification circuitry 310 determines that the verification failed (e.g., block 704 returns a value YES), the rectification circuitry 310 instructs the installation circuitry 304 to copy a first key and a second key from the cloud proxy 102 (FIG. 1) to the host(s) 118 (FIG. 1) (block 706). For example, the installation circuitry 304 is instructed to begin the process of restarting the identified secondary agent(s) 124a-d. In such an example, the installation circuitry 304 copies the secondary public key (first key) and the secondary private key (second key) from the cloud proxy 102 and provides the secondary public key and secondary private key to the host(s) 118 hosting the compute node(s) 114a-d.

The example installation circuitry 304 copies a third key from the example cloud proxy 102 to the example host(s) 118 (block 708). For example, the installation circuitry 304 copies the primary public key and provides the primary public key to the host(s) 118 hosting the compute node(s) 114a-d.

The example installation circuitry 304 uninstalls the identified secondary agent(s) 124a-d to set up an environment reconfiguration (block 710). For example, the installation circuitry 304 restarts the secondary agent(s) 124a-d by uninstalling the secondary agent(s) 124a-d. In some examples, the rectification circuitry 310 uninstalls the identified secondary agent(s) 124a-d. In some examples, the environment reconfiguration is equivalent to an environment shown in FIG. 2 and described in further detail above in connection with FIG. 2.

The example installation circuitry 304 reinstalls the example secondary agent(s) 124a-d (block 712). For example, the installation circuitry 304 instructs the manager(s) 116 to reinstall the secondary agent(s) 124a-d on the compute node(s) 114a-d.

The example installation circuitry 304 utilizes the first key, the second key, and the third key to reconnect the example secondary agent(s) 124a-d to the primary agent 122 (block 714). For example, the installation circuitry 304 may instruct the host(s) 118 to provide the compute node(s) 114a-d with the primary public key, the secondary public key, and the secondary private key to authorize and/or authenticate the connection between the secondary agent(s) 124a-d and the primary agent 122. In some examples, the rectification circuitry 310 instructs the host(s) 118 to provide the compute node(s) 114a-d with the first, second, and third key to establish connectivity between the secondary agent(s) 124a-d and the primary agent 122.

The example rectification circuitry 310 determines whether connectivity was established between the example primary agent 122 and the example secondary agent(s) 124a-d (block 716). For example, the rectification circuitry 310 instructs the primary agent 122 to send a test command (e.g., execute the background thread) to the secondary agent(s) 124a-d. The example rectification circuitry 310 waits for a response from the primary agent 122 to determine whether the secondary agent(s) 124a-d has been successfully reinstalled and/or reconfigured. In some examples, the rectification circuitry 310 instructs the connectivity determination circuitry 308 to verify the connection between the primary agent 122 and the secondary agent(s) 124a-d.

In some examples, when the rectification circuitry 310 determines that connectivity is established (e.g., block 716 returns a value YES), control returns to block 514 of FIG. 5. In some examples, when the rectification circuitry 310 determines that connectivity is not established (e.g., block 716 returns a value NO), control returns to block 706 and the installation circuitry 304 attempts to reconfigure the secondary agent(s) 124a-d by copying the cryptographic keys from the cloud proxy 102 to the host(s) 118. In some examples, the rectification circuitry 310 continues to reconfigure the secondary agent(s) 124a-d until a successful connection is established between the primary agent 122 and the secondary agent(s) 124a-d.

FIG. 8 is a block diagram of an example processor platform 800 structured to execute and/or instantiate the machine readable instructions and/or the operations of FIGS. 5-7 to implement the cloud management circuitry 104 of FIGS. 1 and 3. The processor platform 800 can be, for example, a server, a personal computer, a workstation, a self-learning machine (e.g., a neural network), a mobile device (e.g., a cell phone, a smart phone, a tablet such as an iPad™), or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 812 may be implemented by one or more semiconductor based (e.g., silicon based) devices. In this example, the processor circuitry 812 implements the example installation circuitry 304, the example user interface update circuitry 306, the example connectivity determination circuitry 308, and the example rectification circuitry 310.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 820 implements the example interface 302.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives. In this example, the mass storage devices 828 implement the example datastore 312.

The machine readable instructions 832, which may be implemented by the machine readable instructions of FIGS. 5-7, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 812 of FIG. 8. In this example, the processor circuitry 812 of FIG. 8 is implemented by a microprocessor 900. For example, the microprocessor 900 may be a general purpose microprocessor (e.g., general purpose microprocessor circuitry). The microprocessor 900 executes some or all of the machine readable instructions of the flowchart of FIGS. 5-7 to effectively instantiate the cloud management circuitry 104 of FIGS. 1 and 3 as logic circuits to perform the operations corresponding to those machine readable instructions. In some such examples, the cloud management circuitry 104 of FIGS. 1 and 3 is instantiated by the hardware circuits of the microprocessor 900 in combination with the instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 5-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may be implemented by at least one of an I2C bus, a SPI bus, a PCI bus, or a PCIe bus

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 812 of FIG. 8. In this example, the processor circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 5-7 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowcharts of FIGS. 5-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowcharts of FIGS. 5-7. As such, the FPGA circuitry 1000 may be structured to effectively instantiate some or all of the machine readable instructions of the flowcharts of FIGS. 5-7 as dedicated logic circuits to perform the operations corresponding to those software instructions in a dedicated manner analogous to an ASIC. Therefore, the FPGA circuitry 1000 may perform the operations corresponding to the some or all of the machine readable instructions of FIGS. 5-7 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain machine readable instructions to configure the FPGA circuitry 1000, or portion(s) thereof. In some such examples, the configuration circuitry 1004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may be implemented by external hardware circuitry. For example, the external hardware 1006 may be implemented by the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations that may correspond to at least some of the machine readable instructions of FIGS. 5-7 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowcharts of FIGS. 5-7 may be executed by one or more of the cores 902 of FIG. 9, a second portion of the machine readable instructions represented by the flowcharts of FIGS. 5-7 may be executed by the FPGA circuitry 1000 of FIG. 10, and/or a third portion of the machine readable instructions represented by the flowcharts of FIGS. 5-7 may be executed by an ASIC. It should be understood that some or all of the cloud management circuitry 104 of FIGS. 1 and 3 may, thus, be instantiated at the same or different times. Some or all of the circuitry may be instantiated, for example, in one or more threads executing concurrently and/or in series. Moreover, in some examples, some or all of the cloud management circuitry 104 of FIGS. 1 and 3 may be implemented within one or more virtual machines and/or containers executing on the microprocessor.

In some examples, the processor circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the processor circuitry 812 of FIG. 8, which may be in one or more packages. For example, the XPU may include a CPU in one package, a DSP in another package, a GPU in yet another package, and an FPGA in still yet another package.

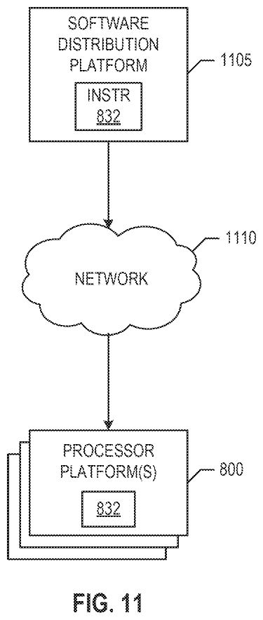

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions 500, 600, and 700 of FIGS. 5-7, as described above. The one or more servers of the example software distribution platform 1105 are in communication with an example network 1110, which may correspond to any one or more of the Internet and/or any of the example networks 108 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions 500, 600, and 700 of FIGS. 5-7, may be downloaded to the example processor platform 800, which is to execute the machine readable instructions 832 to implement the cloud management circuitry 104. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

From the foregoing, it will be appreciated that example systems, methods, apparatus, and articles of manufacture have been disclosed that improve an operation of a cloud computing environment by updating and monitoring connections between compute nodes and management nodes. Disclosed systems, methods, apparatus, and articles of manufacture improve the efficiency of using a computing device by reducing latency of a cloud computing environment that continuously attempts to execute a command without the ability to do so due to connectivity issues. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to improve management operations of a cloud computing environment are disclosed herein. Further examples and combinations thereof include the following:

Example 1 includes an apparatus comprising at least one memory, machine readable instructions, and processor circuitry to at least one of instantiate or execute the machine readable instructions to determine a connectivity status between a first agent operating on a proxy server and a second agent operating on a compute node, the first agent and the second agent executing an application monitoring service, in response to determining that the connectivity status is indicative of a failed connection between the first agent and second agent update the connectivity status of the second agent, and obtain an instruction to rectify the failed connection, and resolve that failed connection between the first agent and the second agent.

Example 2 includes the apparatus of example 1, wherein the first agent is a primary agent that requests metric data from the second agent.

Example 3 includes the apparatus of example 1, wherein the second agent is a secondary agent that runs on the compute node and collects metric data from the compute node in response to instructions from the first agent.

Example 4 includes the apparatus of example 1, wherein the processor circuitry is to periodically execute a background thread to determine the connectivity status between the first agent and the second agent.

Example 5 includes the apparatus of example 1, wherein the processor circuitry is to verify an operating state of the first agent to resolve the failed connection between the first agent and the second agent.

Example 6 includes the apparatus of example 5, wherein the processor circuitry is to reconfigure the first agent in response to determining an unsuccessful operating state of the first agent.

Example 7 includes the apparatus of example 1, wherein the processor circuitry is to verify an operating state of the second agent, in response to an unsuccessful operating state of the second agent provide a first key, a second key, and a third key to the second agent, the first and second cryptographic keys corresponding to the second agent and the third key a cryptographic key corresponding to the first agent, uninstall the second agent, reinstall the second agent, and instruct the second agent to reconnect to the first agent utilizing the first key, second key, and third key, the first, second, and third keys to authenticate a communication between the first agent and second agent.

Example 8 includes a non-transitory machine readable storage medium comprising instructions that, when executed, cause processor circuitry to at least determine a connectivity status between a first agent operating on a proxy server and a second agent operating on a compute node, the first agent and the second agent executing an application monitoring service, in response to determining that the connectivity status is indicative of a failed connection between the first agent and second agent update the connectivity status of the second agent, and obtain an instruction to rectify the failed connection, and resolve that failed connection between the first agent and the second agent.

Example 9 includes the non-transitory machine readable storage medium of example 8, wherein the first agent is a primary agent that requests metric data from the second agent.

Example 10 includes the non-transitory machine readable storage medium of example 8, wherein the second agent is a secondary agent that runs on the compute node and collects metric data from the compute node in response to instructions from the first agent.

Example 11 includes the non-transitory machine readable storage medium of example 8, wherein the instructions, when executed, cause processor circuitry to at least periodically execute a background thread to determine the connectivity status between the first agent and the second agent.

Example 12 includes the non-transitory machine readable storage medium of example 8, wherein the instructions, when executed, cause processor circuitry to at least verify an operating state of the first agent to resolve the failed connection between the first agent and the second agent.

Example 13 includes the non-transitory machine readable storage medium of example 12, wherein the instructions, when executed, cause processor circuitry to at least reconfigure the first agent in response to determining an unsuccessful operating state of the first agent.

Example 14 includes the non-transitory machine readable storage medium of example 8, wherein the instructions, when executed, cause processor circuitry to verify an operating state of the second agent, in response to an unsuccessful operating state of the second agent provide a first key, a second key, and a third key to the second agent, the first and second cryptographic keys corresponding to the second agent and the third key a cryptographic key corresponding to the first agent, uninstall the second agent, reinstall the second agent, and instruct the second agent to reconnect to the first agent utilizing the first key, second key, and third key, the first, second, and third keys to authenticate a communication between the first agent and second agent.

Example 15 includes a method comprising determining a connectivity status between a first agent operating on a proxy server and a second agent operating on a compute node, the first agent and the second agent executing an application monitoring service, in response to determining that the connectivity status is indicative of a failed connection between the first agent and second agent updating the connectivity status of the second agent, and obtaining an instruction to rectify the failed connection, and resolving that failed connection between the first agent and the second agent.

Example 16 includes the method of example 15, wherein the first agent is a primary agent that requests metric data from the second agent.

Example 17 includes the method of example 15, wherein the second agent is a secondary agent that runs on the compute node and collects metric data from the compute node in response to instructions from the first agent.

Example 18 includes the method of example 15, further including periodically executing a background thread to determine the connectivity status between the first agent and the second agent.

Example 19 includes the method of example 15, further including verifying an operating state of the first agent to resolve the failed connection between the first agent and the second agent.

Example 20 includes the method of example 19, further including reconfiguring the first agent in response to determining an unsuccessful operating state of the first agent.

Example 21 includes the method of example 15, further including verifying an operating state of the second agent, in response to an unsuccessful operating state of the second agent providing a first key, a second key, and a third key to the second agent, the first and second cryptographic keys corresponding to the second agent and the third key a cryptographic key corresponding to the first agent, uninstalling the second agent, reinstalling the second agent, and instructing the second agent to reconnect to the first agent utilizing the first key, second key, and third key, the first, second, and third keys to authenticate a communication between the first agent and second agent.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
at least one memory;
machine readable instructions; and
processor circuitry to at least one of instantiate or execute the machine readable instructions to:
determine a connectivity status between a first agent operating on a proxy server and a second agent operating on a compute node, the first agent and the second agent executing an application monitoring service;
in response to determining that the connectivity status is indicative of a failed connection between the first agent and second agent:
update the connectivity status of the second agent; and
obtain an instruction to rectify the failed connection; and
resolve that failed connection between the first agent and the second agent.

2. The apparatus of claim 1, wherein the first agent is a primary agent that requests metric data from the second agent.

3. The apparatus of claim 1, wherein the second agent is a secondary agent that runs on the compute node and collects metric data from the compute node in response to instructions from the first agent.

4. The apparatus of claim 1, wherein the processor circuitry is to periodically execute a background thread to determine the connectivity status between the first agent and the second agent.

5. The apparatus of claim 1, wherein the processor circuitry is to verify an operating state of the first agent to resolve the failed connection between the first agent and the second agent.

6. The apparatus of claim 5, wherein the processor circuitry is to reconfigure the first agent in response to determining an unsuccessful operating state of the first agent.

7. The apparatus of claim 1, wherein the processor circuitry is to:
verify an operating state of the second agent;
in response to an unsuccessful operating state of the second agent:
provide a first key, a second key, and a third key to the second agent, the first and second cryptographic keys corresponding to the second agent and the third key a cryptographic key corresponding to the first agent;
uninstall the second agent;
reinstall the second agent; and
instruct the second agent to reconnect to the first agent utilizing the first key, second key, and third key, the first, second, and third keys to authenticate a communication between the first agent and second agent.

8. A non-transitory machine readable storage medium comprising instructions that, when executed, cause processor circuitry to at least:
determine a connectivity status between a first agent operating on a proxy server and a second agent operating on a compute node, the first agent and the second agent executing an application monitoring service;
in response to determining that the connectivity status is indicative of a failed connection between the first agent and second agent:
update the connectivity status of the second agent; and
obtain an instruction to rectify the failed connection; and
resolve that failed connection between the first agent and the second agent.

9. The non-transitory machine readable storage medium of claim 8, wherein the first agent is a primary agent that requests metric data from the second agent.

10. The non-transitory machine readable storage medium of claim 8, wherein the second agent is a secondary agent that runs on the compute node and collects metric data from the compute node in response to instructions from the first agent.

11. The non-transitory machine readable storage medium of claim 8, wherein the instructions, when executed, cause processor circuitry to at least periodically execute a background thread to determine the connectivity status between the first agent and the second agent.

12. The non-transitory machine readable storage medium of claim 8, wherein the instructions, when executed, cause processor circuitry to at least verify an operating state of the first agent to resolve the failed connection between the first agent and the second agent.

13. The non-transitory machine readable storage medium of claim 12, wherein the instructions, when executed, cause processor circuitry to at least reconfigure the first agent in response to determining an unsuccessful operating state of the first agent.

14. The non-transitory machine readable storage medium of claim 8, wherein the instructions, when executed, cause processor circuitry to:
verify an operating state of the second agent;
in response to an unsuccessful operating state of the second agent:
provide a first key, a second key, and a third key to the second agent, the first and second cryptographic keys corresponding to the second agent and the third key a cryptographic key corresponding to the first agent;
uninstall the second agent;
reinstall the second agent; and
instruct the second agent to reconnect to the first agent utilizing the first key, second key, and third key, the first, second, and third keys to authenticate a communication between the first agent and second agent.

15. A method comprising:
determining a connectivity status between a first agent operating on a proxy server and a second agent operating on a compute node, the first agent and the second agent executing an application monitoring service;
in response to determining that the connectivity status is indicative of a failed connection between the first agent and second agent:
updating the connectivity status of the second agent; and
obtaining an instruction to rectify the failed connection; and
resolving that failed connection between the first agent and the second agent.

16. The method of claim 15, wherein the first agent is a primary agent that requests metric data from the second agent.

17. The method of claim 15, wherein the second agent is a secondary agent that runs on the compute node and collects metric data from the compute node in response to instructions from the first agent.

18. The method of claim 15, further including periodically executing a background thread to determine the connectivity status between the first agent and the second agent.

19. The method of claim 15, further including verifying an operating state of the first agent to resolve the failed connection between the first agent and the second agent.

20. The method of claim 19, further including reconfiguring the first agent in response to determining an unsuccessful operating state of the first agent.

21. The method of claim 15, further including:
verifying an operating state of the second agent;
in response to an unsuccessful operating state of the second agent:
providing a first key, a second key, and a third key to the second agent, the first and second cryptographic keys corresponding to the second agent and the third key a cryptographic key corresponding to the first agent;
uninstalling the second agent;
reinstalling the second agent; and
instructing the second agent to reconnect to the first agent utilizing the first key, second key, and third key, the first, second, and third keys to authenticate a communication between the first agent and second agent.
